(19) United States
(12) Patent Application Publication
(10) Pub. No.: US 2020/0316623 A1
(43) Pub. Date: Oct. 8, 2020

(54) COAXIAL ELECTROSPRAY DEVICES AND RELATED METHODS

(71) Applicant: Massachusetts Institute of Technology, Cambridge, MA (US)

(72) Inventor: Luis Fernando Velásquez-García, (US)

(73) Assignee: Instituto Technologico y de Estudios Superiores de Monterrey, Monterrey (MX)

(21) Appl. No.: 16/303,890

(22) PCT Filed: May 24, 2017
(86) PCT No.: PCT/US2017/034287

§ 371 Date: Nov. 21, 2018

Related U.S. Application Data
(60) Provisional application No. 62/341,162, filed on May 25, 2016.

(51) Int. Cl. B05B 5/053; B05B 5/057; B29C 64/10

(52) U.S. Cl. CPC B05B 5/0536; B29C 64/10; B05B 5/057

(57) ABSTRACT

Electrospray devices are described. The devices may comprise a substrate and a plurality of emitters. The emitters may comprise a plurality of channels therein, wherein the channels may be configured to convey immiscible liquids to the distal end of the emitters. The channels may be arranged such that, at the distal end, one liquid enclosed another liquid. The device may comprise a plurality of reservoirs, each reservoir being configured to contain liquid therein and to convey the liquid to a respective channel. Core-shell droplets may be formed by forming Taylor cones through the application of an electric field. The core-shell droplets may include a core liquid enclosed within a shell liquid, wherein the two liquids may be immiscible.

### RELATED APPLICATIONS

This Application claims priority under 35 U.S.C. § 119(e) to U.S. Provisional Patent Application Ser. No. 62/341,162, entitled “HIGH THROUGHPUT GENERATION OF CORE-SHELL PARTICLES USING MONOLITHIC ARRAYS OF COAXIAL ELECTROSPRAY EMITTERS MADE WITH 3D PRINTING” filed on May 25, 2016, which is herein incorporated by reference in its entirety.

### BACKGROUND

Electrospray, also known as electro-hydrodynamic atomization, is a technique that consists in the injection of a liquid through capillary electrical field emitters, typically using metal needles. For a specific range of applied electric field and liquid injection flow rate, the electrified meniscus (i.e., the curve in the free surface of a liquid) forms a “Taylor cone”, i.e., a cone of liquid having a convex shape that is different from the shape caused by surface tension alone. When the Taylor cone is formed, a thin, electrically charged, steady jet of liquid breaks the surface tension and gives rise to fine droplets.

### BRIEF SUMMARY

According to one aspect of the present application, a coaxial electrospray is provided. The coaxial electrospray device may comprise a substrate, an emitter having a proximal end and a distal end, the proximal end being connected to a surface of the substrate, wherein the emitter comprises therein a first channel and a second channel, and wherein the first and second channels extend to the distal end of the emitter, and first and second reservoirs formed in the substrate, the first reservoir being coupled to the first channel and the second reservoir being coupled to the second channel.

In some embodiments, the first channel encloses the second channel within at least a portion of the emitter.

In some embodiments, the emitter has a first width at the distal end of the emitter and a second width at the proximal end of the emitter, the second width being larger than the first width.

In some embodiments, the first and second channels have helical shapes.

In some embodiments, the coaxial electrospray device further comprises a spout connected to the distal end of the emitter, wherein the spout comprises an inner tank and an outer tank enclosing the inner tank, wherein the first channel is coupled to the outer tank and the second channel is coupled to the inner tank.

In some embodiments, at least one of the first and second reservoirs comprises one or more columns.

In some embodiments, the first and second channels have tapered shapes.

In some embodiments, each of the first and second channels has a first width at the distal end of the emitter and a second width at the proximal end of the emitter, the second width being larger than the first width.

In some embodiments, the first channel has a width that varies continuously between the first width and the second width.

In some embodiments, the emitter has a width at the distal end that is between 50 μm and 1 mm.

In some embodiments, the emitter has a truncated conical shape.

In some embodiments, the substrate is made of a material having a relative dielectric constant that is between 1.0 and 15.

In some embodiments, the substrate is made of a material selected from a group consisting of a polymer and a ceramic.

In some embodiments, the coaxial electrospray device further comprises a plurality of emitters, one of the plurality of emitters being the emitter, each of the plurality of emitters having a proximal end and a distal end, the proximal end being connected to the surface of the substrate, wherein each of the plurality of emitters comprises therein a first channel and a second channel extending to a respective distal end of the emitter, and wherein each of the first channels is coupled to the first reservoir and each of the second channels is coupled to the second reservoir.

In some embodiments, the plurality of emitters are arranged with a surface density that is between 1 emitter/cm² and 1000 emitters/cm².

In some embodiments, the plurality of emitters are arranged in a honeycomb configuration.

In some embodiments, the first channel has a length, measured between the distal end of the emitter and the proximal end of the emitter, that is between 10 and 1000 times larger than a maximum width of the first channel.

In some embodiments, at least one between the first and the second channel comprises a plurality of supporting beams.

According to another aspect of the present application, a method is provided. The method may comprise conveying a first liquid into a first inlet of a substrate and a second liquid into a second inlet of the substrate, the first and second liquids being immiscible; causing the first liquid to enter a first reservoir formed in the substrate and the second liquid to enter a second reservoir formed in the substrate; causing the first liquid to form a first plurality of menisci in respective emitters of a plurality of emitters, the plurality of emitters being connected to and protruding from the substrate, and causing the second liquid to form a second plurality of menisci in the respective emitters, wherein at least one meniscus of the second plurality of menisci encloses, in a plane, a respective meniscus of the second plurality of menisci; and causing the at least one meniscus of the first plurality of menisci and the at least one meniscus of the second plurality of menisci to form a Taylor cone.

In some embodiments, causing the at least one meniscus of the first plurality of menisci and the at least one meniscus of the second plurality of menisci to form a Taylor cone comprises exposing the plurality of emitters to an electric field.

In some embodiments, the electric field has a magnitude, in a region proximate the plurality of emitters, sufficiently large to generate an electric force larger than a maximum surface tension of the first and second plurality of menisci.

In some embodiments, each meniscus of the second plurality of menisci encloses a respective meniscus of the second plurality of menisci.

According to yet another aspect of the present application, a method for fabricating a coaxial electrospray device is provided. The method may comprise 3D printing a substrate; 3D printing an emitter with a proximal end and a distal end, the proximal end being connected to a surface of the substrate, wherein the emitter comprises therein a first channel and a second channel, and wherein the first and second channels extend to the distal end of the emitter; and wherein 3D printing the substrate comprises forming first and second reservoirs, the first reservoir being coupled to the first channel and the second reservoir being coupled to the second channel.

In some embodiments, the 3D printing of the substrate and the emitter is based on an output file defining a plurality of slices.

In some embodiments, the output file includes jagged edges.

In some embodiments, the method further comprises forming a spout such that the spout is connected to the distal end of the emitter, wherein the spout comprises an inner tank and an outer tank enclosing the inner tank, wherein the first channel is coupled to the outer tank and the second channel is coupled to the inner tank.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in all the figures in which they appear.

FIG. 1A is a schematic illustration of a representative electrospray device, according to some non-limiting embodiments.

FIGS. 1B-1C are cross sectional views of the electrospray device of FIG. 1A, according to some non-limiting embodiments.

FIGS. 1D-1E are schematic views illustrating a representative emitter comprising a plurality of supporting beams, according to some non-limiting embodiments.

FIG. 2A is a schematic illustration of another representative electrospray device, according to some non-limiting embodiments.

FIG. 2B is a schematic illustration of a representative spout, according to some non-limiting embodiments.

FIGS. 2C-2D are cross sectional views of the electrospray device of FIG. 2A, according to some non-limiting embodiments.

FIG. 3 is a schematic illustration of a representative electrospray device comprising a plurality of emitters, according to some non-limiting embodiments.

FIGS. 4A-4C are schematic views of representative reservoirs comprising a plurality of columns, according to some non-limiting embodiments.

FIG. 5A is a schematic illustration of a system for generating core-shell droplets, according to some non-limiting embodiments.

FIG. 5B is a schematic illustration of a representative core-shell droplet, according to some non-limiting embodiments.

FIG. 6 is an exploded view of another representative electrospray device, according to some non-limiting embodiments.

FIG. 7A is an isometric view of another representative electrospray device, according to some non-limiting embodiments.

FIG. 7B is a side view of the electrospray device of FIG. 7A, according to some non-limiting embodiments.

FIG. 7C is a top view of the electrospray device of FIG. 7A, according to some non-limiting embodiments.

FIG. 8 is a representative setup for testing electrospray devices, according to some non-limiting embodiments.

FIGS. 9A-9B illustrates representative co-flowing liquid jets, according to some non-limiting embodiments.

FIGS. 10A-10D are plots illustrating examples of measurements of emitter current, according to some non-limiting embodiments.

FIG. 11 illustrates a plurality of core-shell droplets, according to some non-limiting embodiments.

FIGS. 12A-12C are plots illustrating droplet diameter distributions, according to some non-limiting embodiments.

FIGS. 13A-13B are flowcharts illustrating representative processes for fabricating coaxial electrospray devices, according to some non-limiting embodiments.

### DETAILED DESCRIPTION

### I. Overview

The inventors have recognized and appreciated a fundamental impediment in conventional coaxial electrospray devices that limits the ability to produce monodisperse core-shell particles in large volumes. Coaxial electrospray is a particular subset of electrospray, in which droplets are formed that have a core substance encapsulated within a shell substance. Coaxial electrospray is a technique that potentially finds application in several engineering and biomedical settings, including in the production of drug-loaded microcapsules with precise control of the core-shell geometry. However, this potential is still unmet due to the inability of current techniques to produce microcapsules in large quantities. In fact, in conventional techniques, any increase in throughput inevitably result in loss of uniformity; for example, this is achieved by different approaches including increasing the electric field acting on the emitter to the point to generate multiple cones per emitter. That is, when the rate at which microcapsules are generated is increased, the geometry of the fabricated microcapsules becomes unpredictable. Since in most application a precise control of the size and geometry of the microcapsules is a sine qua non, the applicability of these techniques is substantially decreased.

Accordingly, the inventors have developed systems and methods for coaxial electrospray that meet the throughput requirement in most applications. Unlike conventional techniques, the systems and methods developed by the inventors break the trade-off condition between throughput and accuracy control.

Some embodiments of the present application are directed to electrospray devices that include multiple emitters integrated into single substrates. In this way, multiple Taylor cones (and thus multiple jets) can be formed in parallel (e.g., one Taylor cone per emitter). Since the Taylor cones, in some embodiments, share the same liquids, the overall rate at which droplets are created can be substantially increased. Furthermore, since the emitters are fabricated as one piece using the same fabrication process, emitter array assembly is obviated; in addition, the emitters are subjected to the same fabrication tolerances, and therefore the likelihood of substantial variations in their geometries is limited.

The inventors have further developed processes for manufacturing coaxial electrospray devices that enable not only accurate control of the geometry of the emitters and ability to integrate large numbers of emitters, but also high manufacturing rates. Given the three-dimensional nature of the devices developed by the inventors, conventional techniques, which are essentially two-dimensional processes adapted to generate three-dimensional shapes, are found unsuitable. For example, microelectromechanical systems (MEMS) processes are configured to produce three-dimensional objects by selectively etching material in a layer-by-layer fashion, thus requiring the use of large numbers of photomasks, which renders the process cumbersome and expensive. In contrast, the processes developed by the inventors are innately three-dimensional. For example, in some embodiments, multi-emitter coaxial electrospray devices of the type described herein are fabricated using stereolithographic techniques. Accordingly, the devices are formed additively from the photopolymerization of resins using ultraviolet light, with the help of computer aided manufacturing (CAM) or computer aided design software (CAD). Compared to conventional techniques which have been traditionally used to fabricate single-emitter devices, this technique reduces fabrication time and costs.

As explained above, some embodiments of the present application relate to multi-emitter coaxial electrospray devices. These devices have geometries configured to inject two immiscible liquids at appropriate flow rates through a pair of capillary channels, where one capillary channel encloses the other, at least partially. When the liquids are exposed to an electric field having a suitable magnitude, the menisci of the liquids give rise to coaxial Taylor cones that result in the generation of a co-flowing jet. The jet breaks up into droplets wherein one liquid is contained within the other liquid. If the shell material is made of a photopolymerazible material, when exposed to light having a suitable intensity and wavelength (e.g., in the ultraviolet), the droplets can be transformed into capsules having a solid core and/or a solid shell.

### II. Coaxial Electrospray Devices

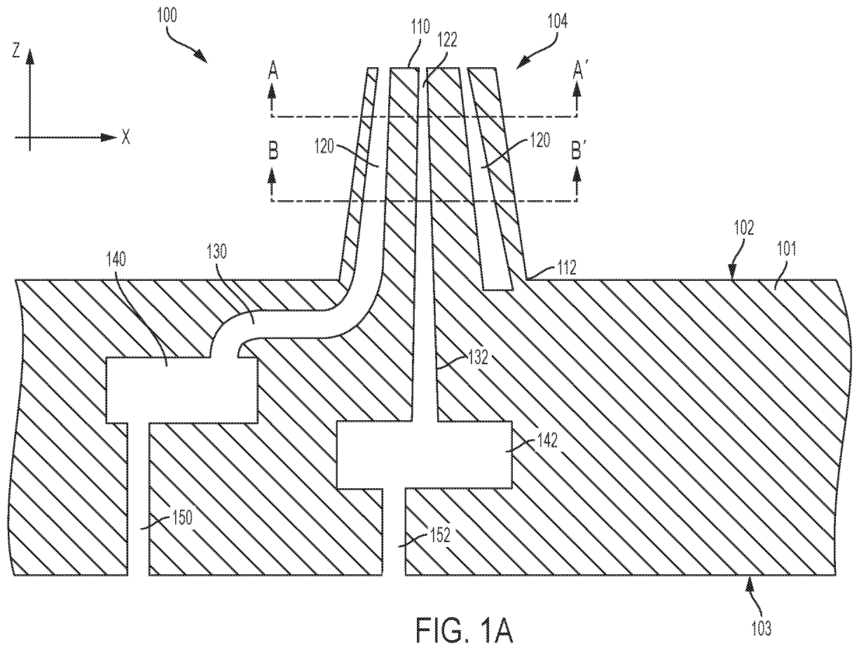

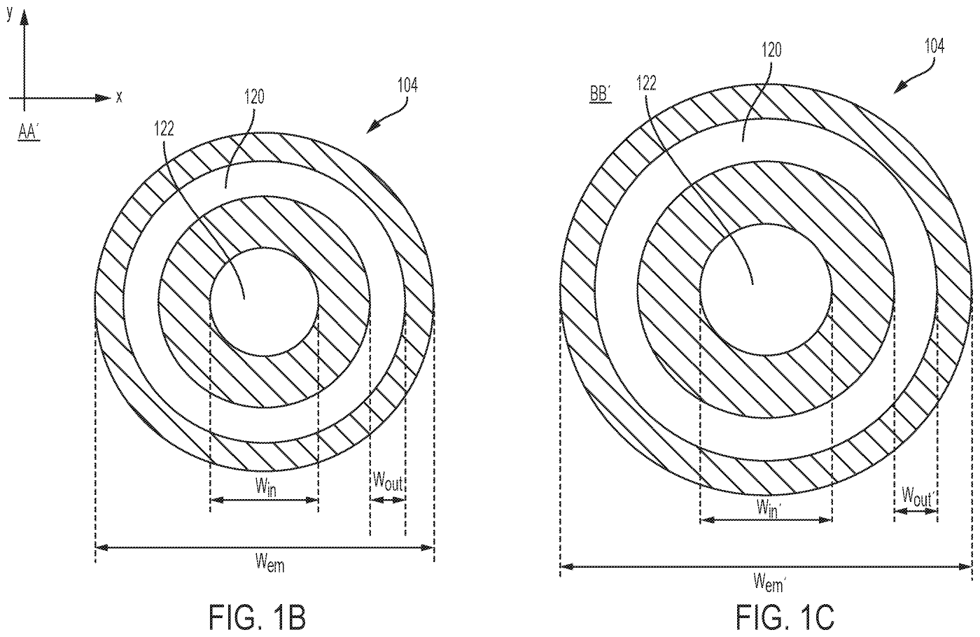

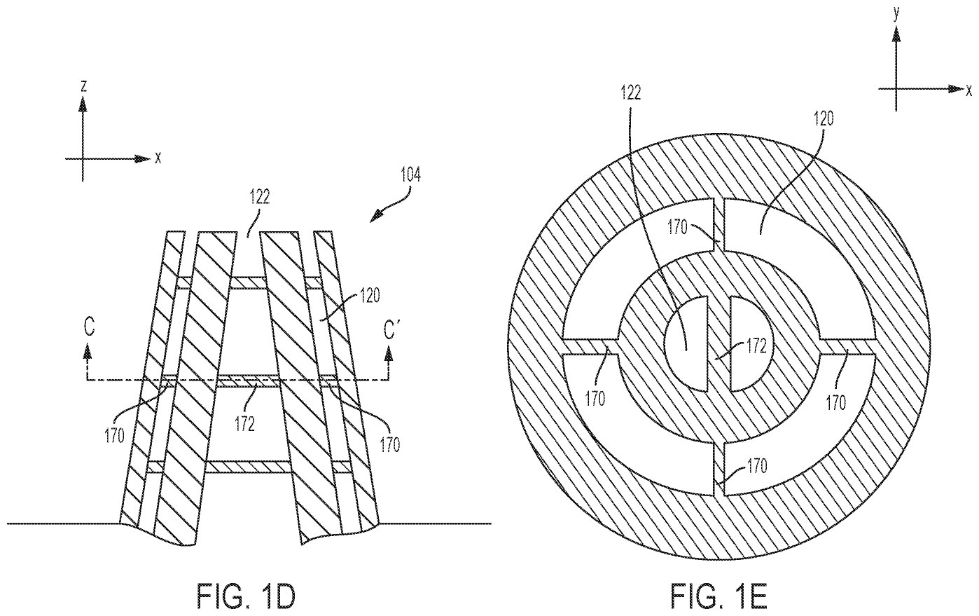

FIG. 1A is a cross-sectional view of a representative coaxial electrospray device, according to some non-limiting embodiments. Representative multi-emitter coaxial electrospray device 100 (also referred to herein as “electrospray device 100”, or simply as “device 100”) includes a substrate 101 having a top surface 102 and a bottom surface 103, and one or more emitters 104 (though only one emitter is depicted in FIG. 1A). Substrate 101 can be made of any of numerous materials. In some embodiments, substrate 101 is made of a dielectric material (e.g., any material having a relative dielectric constant that is between 1 and 15) so as to let the liquid itself increase the electric field within its boundaries when exposed to an external electric field. As will be described further below, enhancing the electric field may be beneficial as it may reduce the voltage necessary to form Taylor cones. For example, substrate 101 may be made of aluminum oxide, nylon, PTE, TPU, ABS and/or ABS-like materials, or using any other suitable combination of ceramics, resins, polymers and/or plastics. Emitter(s) 104 may be made of the same material as substrate 101. In some embodiments, device 100 is fabricated using stereolithographic techniques, though other 3D printing techniques may alternatively be used.

As illustrated, substrate 101 and emitter 104 include a network of channels for conveying a pair of liquids to a suitable location for generating a co-flowing jet. As will be described further below, a co-flowing jet may break up into micro-droplets in which a core liquid is enclosed by a shell liquid. The network includes reservoirs 140 and 141, inlets 150 and 152, channels 120 and 122, and intermediate channels 130 and 132. In particular, a first network includes reservoir 140, inlet 150, channel 120, and intermediate channel 130, and a second network includes reservoir 142, inlet 152, channel 122, and intermediate channel 132. In some embodiments, the two networks are independent from one another, thereby preventing the liquids from mixing with one another. The liquids may be conveyed into device 100 through inlets 150 and 152. In the embodiment illustrated in FIG. 1A, the inlets are formed in the back surface 103 of substrate 101 so as to prevent direct contact of the liquids with emitter 104. However, the application is not limited in this respect as the inlets may be alternatively formed on the top surface 102, or in any other suitable part of substrate 101. Inlets 150 and 152 are arranged to convey the liquids into reservoirs 140 and 142, respectively. The reservoirs may be positioned and sized to control the flow rates with which the liquids are provided to the emitter 104.

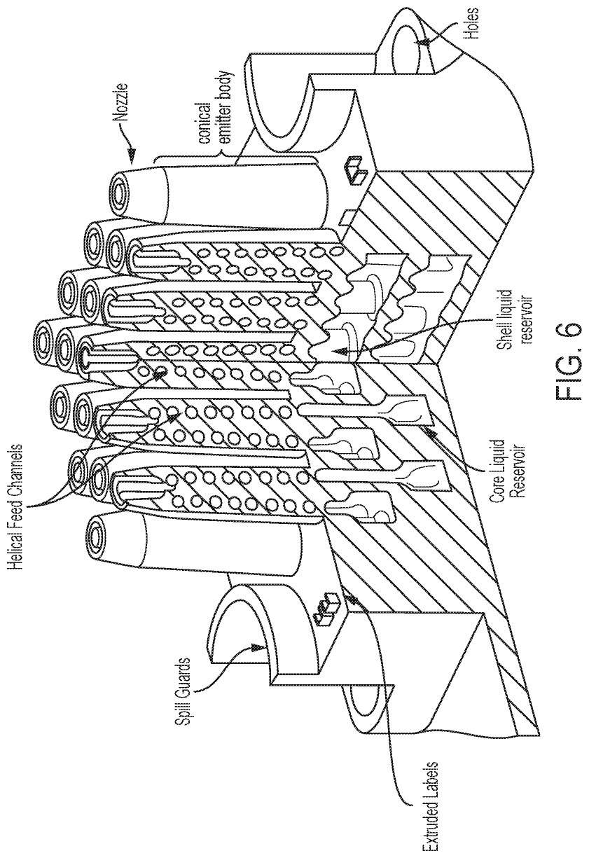

When the reservoirs are at least partially filled, the liquids are conveyed to channels 120 and 122, which are formed in the emitter 104, via intermediate channels 130 and 132, respectively. While FIG. 1A illustrates the reservoirs 150 and 152 as being offset from one another, along the x-axis, other configurations are also possible. For example, the reservoirs 150 and 152 may be arranged to be stacked on one another along the z-axis (this configuration is illustrated in the non-limiting example of FIG. 6, which is discussed further below).

Emitter 104 has a proximate end 112 that is connected to the top surface 102 of substrate 101, and a distal end 110. In some embodiments, emitter 104 protrudes from top surface 102 along a direction that is perpendicular to top surface 102. Of course, emitter 104 may alternatively protrude at an angle with respect to the axis perpendicular to top surface 102. Channels 120 and 122 are arranged such that, at the distal end 110 of emitter 104, one liquid encloses the other liquid in the xy-plane. Two plane views of emitter 104, taken along lines AA′ and BB′ in the xy-plane, are illustrated in FIGS. 1B and 1C respectively. As illustrated in these plane views, channel 120 encloses channel 122. In some embodiments, the two channels are coaxial so as to promote symmetry in the co-flowing jet coming out of emitter 104. However, the application is not limited in this respect as the axis of channel 120 need not be the same as the axis of channel 122.

In some embodiments, emitter 104 has a tapered shape, such that the width of the emitter decreases away from top surface 102. For example, the width of the emitter in the plane defined by line AA′ (see FIG. 1B, width Wₑₘ) may be smaller than the width in the plane defined by line BB′ (see FIG. 1C, width Wₑₘ′), wherein line BB′ is closer than line AA′ to top surface 102. In some embodiments, the width of emitter 104 decreases linearly from proximate end 112 to distal end 110. For example, emitter 104 may have a truncated conical shape (a cone having the apex cut away). In this case, the widths Wₑₘ and Wₑₘ′ represent the diameter, at different distances from top surface 102, of emitter 104. Of course, other shapes for emitter 104 may be used. Having a tapered shape may cause the electric field to be enhanced in the region near the distal end 110, where the liquids' menisci are formed. Enhancing the electric field in this region may be beneficial as it may reduce the voltage necessary to overcome the surface tension at the menisci (which is referred to herein as the “threshold voltage”) and hence form Taylor cones.

In some embodiments, it may be desirable to slow down the rate at which liquid pressure builds up in channels 120 and 122. This may be the case, for example, when multiple emitters 104 are formed on substrate 101. In certain circumstances, the hydraulic impedance associated with the various emitters may be non-uniform, and as a result some emitters may be filled with liquid before others. To promote uniformity in the rate at which the emitters are filled, in some embodiments, channels 120 and 122 have a large aspect ratio (i.e., length-to-width ratio, where the length is measured along the axis of propagation of liquid in the channel), thereby increasing hydraulic impedance. For example, the channels may have an aspect ratio that is between 10 and 10000, between 10 and 1000, between 100 and 1000, between 10 and 100, or between any range within such ranges. In some embodiments, the minimum width of the channels is between 50 μm and 1 mm, between 50 μm and 800 μm, between 50 μm and 500 μm, between 50 μm and 250 μm, between 50 μm and 100 μm, between 200 μm and 800 μm, between 500 μm and 800 μm, or between any suitable range within such ranges.

In some embodiments, channels 120 and 122 (or at least one of them) have tapered shapes such that their widths decrease away from top surface 102. Having tapered shapes may be beneficial to decouple the pressure necessary to fill in the channels in the emitter from the pressure needed to create a meniscus at the tip of the emitter. This configuration may be used to promote pressure uniformity across multiple emitters. For example, the width of channel 120 in the plane defined by line AA′ (see FIG. 1B, width Wᵢₙ) may be smaller than the width in the plane defined by line BB′ (see FIG. 1C, width Wᵢₙ′). Similarly, the width of channel 122 in the plane defined by line AA′ (see FIG. 1B, width Wₒᵤₜ) may be smaller than the width in the plane defined by line BB′ (see FIG. 1C, width Wₒᵤₜ′). In some embodiments, the width of the channels 104 decreases continuously (without discontinuities) from proximate end 112 to distal end 110. In one example, the widths decrease linearly away from top surface 102.

Intermediate channels 130 and 132 may have geometries configured to decouple the pressure necessary to fill in the channels in the emitter 104 from the pressure needed to set a desired flow rate. For example, in some embodiments, the intermediate channels may have tapered shapes, such that their widths are decreased closer to the emitter 104.

To prevent the channels from collapsing, in some embodiments, supporting beams are formed. Representative supporting beams are illustrated in FIGS. 1D-1E, where FIG. 1D is a cross-sectional view and FIG. 1E is a plane view taken in a plane defined by line CC′. As illustrated in these figures, supporting beams 170 are formed inside channel 120 and supporting beams 172 are formed inside channel 122. It should be appreciated that, in some embodiments, only one channel may comprise supporting beams. The supporting beams may be made of the same material used for emitter 104, and may connect the inner wall of a channel to its outer wall. As illustrated in FIG. 1D, multiple supporting beams may be formed at different locations along the length of emitter. As illustrated in FIG. 1E, multiple beams may be formed in one plane. In some embodiments, at least some of the supporting beams are radially oriented (e.g., pointing toward the center of emitter 104).

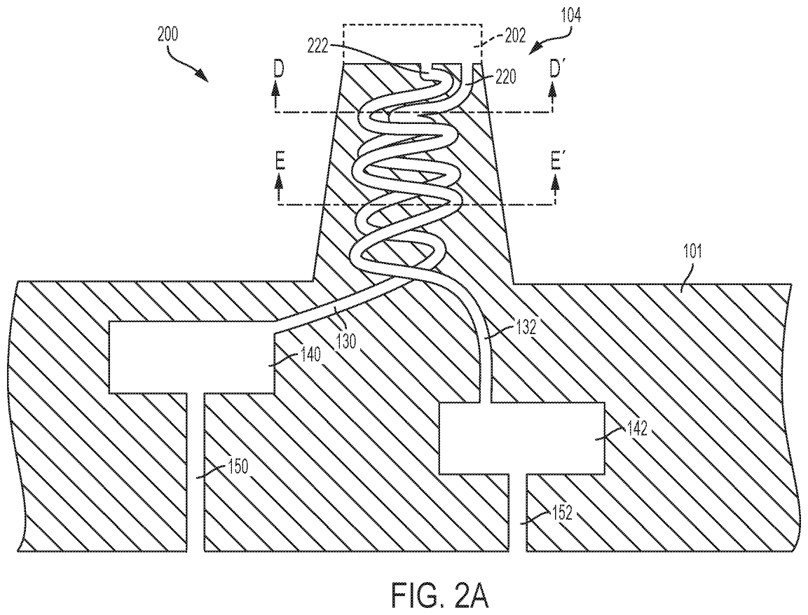

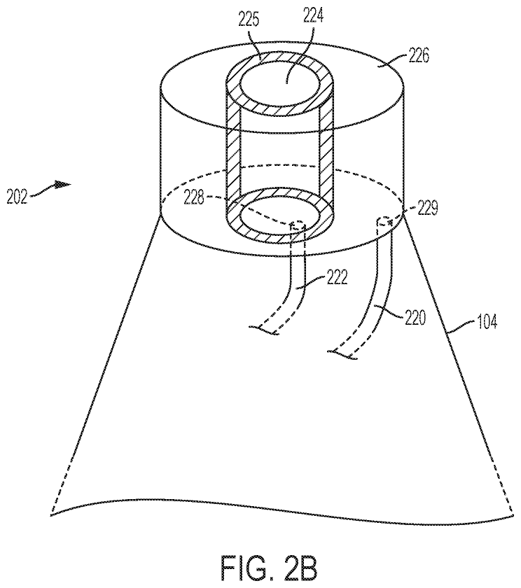

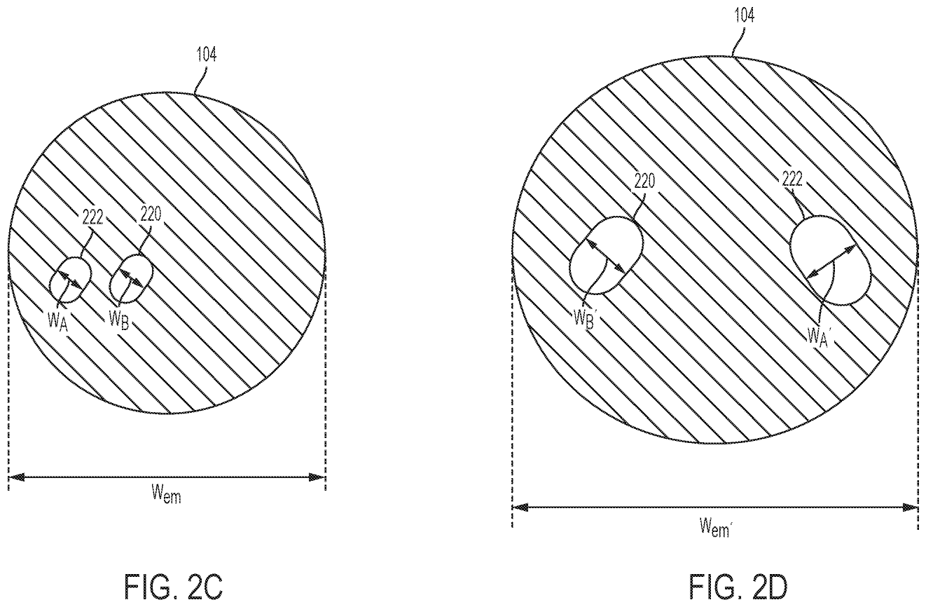

In the configurations illustrated in FIGS. 1A-1E, the channels are arranged such that one channel encloses the other channel. This is to ensure that one liquid encloses the other liquid (in the xy-pane) at the output of the emitter, such that core-shell droplets can be formed. However, the inventors have appreciated that alternative configurations for achieving this results can be used. In one example, an emitter may include interleaved channels (for example in a double-helix arrangement), and a spout including an inner tank and an outer tank, wherein each channel conveys liquid to a respective tank of the spout. This arrangement is illustrated in FIGS. 2A-2C. Like in device 100, device 200 includes substrate 101, reservoirs 140 and 142, inlets 150 and 152, and intermediate channels 130 and 132. However, in this case, emitter 104 includes a pair of channels 220 and 222 that do not encloses one another as in FIG. 1A. In the example of FIG. 2A, each of channels 220 and 222 is arranged in a helix-like configuration, such that it wraps multiple times around a respective axis. In some embodiments, channel 220 and 222 are wound around the same axis, such as the axis of symmetry of emitter 104. However, other helical configurations are also possible and emitter 104 need not have an axis of symmetry. The inventors have appreciated that, winding the channels as described herein may allow for the formation of longer channels while limiting the overall dimensions of emitter 104. In this way, more emitters per unit area and per unit of volume can be integrated on substrate 101 without sacrificing the channels' aspect ratios. It should be appreciated that channels 220 and 222 need not be interleaved, helical, wrapped or even curved, as the application is not limited to any specific arrangement. For example, in in some embodiments, channels 220 and 222 may be straight.

To ensure that core-shell droplets are created wherein one liquid encloses the other liquid, a spout may be used. As illustrated in FIG. 1A, spout 202 is attached to the distal end of emitter 104. A possible non-limiting implementation of spout 202 is illustrated in FIG. 1B. In this configuration, spout 202 includes an inner tank 224 and an outer tank 226, wherein the inner tank and the outer tank are separated by wall 225. The bottom surface of spout 202 may be flush with the distal end of emitter 104. To convey liquid to the spout, tank 224 has an opening 228 formed on the bottom surface of the spout, and tank 226 has an opening 229. As illustrated, channel 222 is coupled to tank 224 via opening 228, and channel 220 is coupled to tank 226 via opening 229. The tanks may be coaxial in some embodiments, though the application is not limited to this arrangement.

As in device 100, channels 220 and 222 may have large aspect ratios (e.g., between 10 and 10000, between 10 and 1000, between 100 and 1000, between 10 and 100, or between any range within such ranges), so as to provide a large hydraulic impedance. In some embodiments, the width of the channels may be decreased along the length of a channel, thereby providing increasingly higher hydraulic impedance. For example, the width of channel 222 in the plane defined by line DD′ (see FIG. 2C, width W_{A}) may be smaller than the width in the plane defined by line EE′ (see FIG. 2D, width W_{A}). Similarly, the width of channel 220 in the plane defined by line DD′ (see FIG. 2C, width W_{B}) may be smaller than the width in the plane defined by line EE′ (see FIG. 2D, width W_{B}′). In some embodiments, the minimum width of the channels 220 and 222 is between 50 μm and 1 mm, between 50 μm and 800m, between 50 μm and 500m, between 50 μm and 250m, between 50 μm and 100m, between 200 μm and 800m, between 500 μm and 800m, or between any suitable range within such ranges.

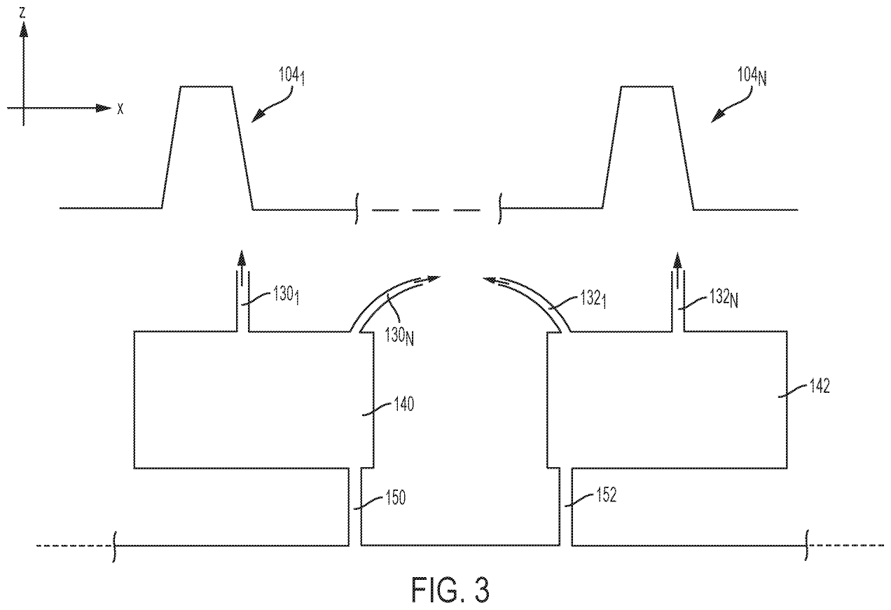

As described above, substrate 101, whether in the configuration of FIG. 1A, the one of FIG. 2A or in any other suitable configuration, may include a plurality of emitters 104. In this way, the overall rate at which core-shell droplets are generated is increased, thus increasing the device's throughput without sacrificing the uniformity of the core-shell particles. FIG. 3 illustrates a coaxial electrospray device comprising a plurality of emitters 104. Though not illustrated in FIG. 3, the emitters' channels may be arranged according to the configuration of FIG. 1A, FIG. 2A, or any other suitable configuration. As illustrated, reservoir 140 is coupled to N intermediate channels 130₁ . . . 130_{N}, and reservoir 142 to N intermediate channels 132₁ . . . 132_{N}. Each channel may feed liquid to a respective emitter. For example, channels 130₁ and 132₁ feed respective liquids to emitter 104₁ and channels 130_{N} and 132_{N} feed respective liquids to emitter 104_{N}. As described above, the overall hydraulic impedance between the inlet and the distal end of an emitter may be non-uniform in some circumstances. Such uniformities may be caused by a variety of reasons, including non-uniformities in the path lengths between an inlet and an emitter's distal end. As a result, some emitters may be filled with liquid prior to other emitters and/or with a different liquid pressure. This behavior may lead to disparities in the rates at which droplets are formed from the different emitters and/or in the geometry of the droplets. To obviate these uniformities, the overall impedance of the channels may be increased, thereby decreasing the relative variations in hydraulic impedance. As described above, this may be achieved by providing channels with large aspect ratios and/or by tapering the channels.

The emitters may be integrated with a density that is, for example, between 1/cm² and 1000/cm², between 1/cm² and 50/cm², between 25/cm² and 100/cm², between 25/cm² and 100/cm², or between any range within such ranges. In some embodiments, the emitters are arranged on the top surface 102 in a honeycomb configuration. Of course, other configurations are also possible.

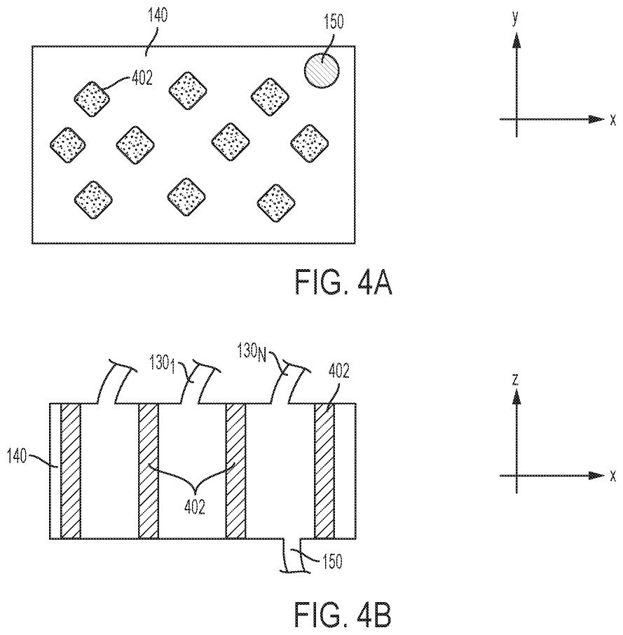

As illustrated in FIG. 3, each reservoir may feed liquid to a plurality of emitters. However, depending on the location where a respective intermediate channel is coupled to a reservoir, different flow rates may arise. For example, intermediate channel 130₁, which is coupled to reservoir 140 near its center may exhibit a different flow rate with respect to intermediate channel 130_{N}, which is coupled to reservoir 140 near one of it edges. Variations in the flow rates may give rise to non-uniformities in the geometry and/or rates of the droplets. To uniformize the flow rates of the channels, in some embodiments, the reservoirs may comprise columns. One such configurations is illustrated in FIGS. 4A-4B. In this case, reservoir 140 includes a plurality of columns 402.

The columns may be sized and positioned to promote flow rate uniformity among the intermediate channels 130₁ . . . 130_{N}. The columns may have squared cross-section in some embodiments. In some embodiments, the square may have rounded corners, thereby limiting perturbations in the liquid near the corners. In some embodiments, the columns may be arranged in a honeycomb configuration, as illustrated in FIG. 4A. The presence of the columns may alter the effective viscosity of the liquid inside the reservoir in such a way so as to promote uniform conveyance into the various intermediate channels. The number and size of the columns may be arranged to provide a desired viscosity, without substantially reducing the liquid's pressure. The presence of the columns may also prevent the reservoir from collapsing. Though not illustrated, reservoir 142 may have a similar configuration.

In some embodiments, to improve space utilization within substrate 101, intermediate channels may be formed within the columns described above. One example of this configuration is illustrated in FIG. 4C. In this case, reservoirs 140 and 142 overlap, at least partially, along the x-axis. As illustrated, the intermediate channels 132₁, 132₂, and 132₃, which connect reservoir 142 to emitters 140₁, 140₂ and 140₃, respectively, pass through columns 402. The emitters' channels may be arranged according to any one of the configurations described above. The other liquid is provided via intermediate channels 130₁, 130₂, etc. Inlet 150 may pass through a column 403 of reservoir 142, though other configurations are also possible. Of course, devices of the type described herein are not limited to include three emitters, as any suitable number of emitters may be used.

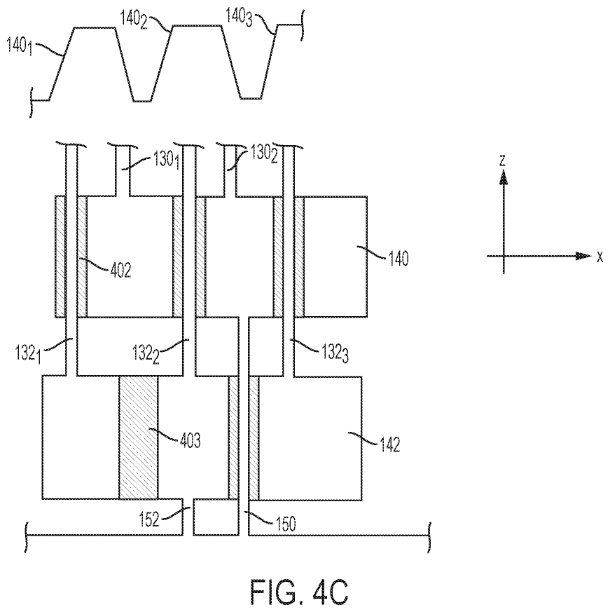

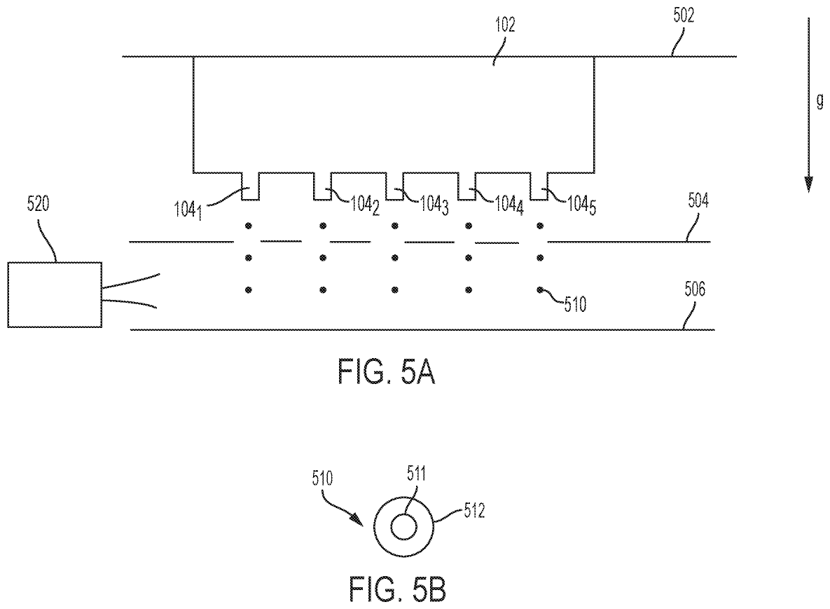

The embodiments described herein may be used to generate co-flowing jets of immiscible liquids. Under certain circumstances, the jets may give rise to droplets having a core liquid enclosed within a shell liquid (referred to herein as core-shell droplets). This may be the case when the emitters 104 are exposed to an electric field having a magnitude sufficiently large to overcome the surface tension of the liquids menisci, thereby forming a Taylor cone. A representative configuration for generating core-shell droplets is illustrated in FIG. 5A. As illustrated, device 100 may be oriented such that droplets arising out of emitters 104₁, 104₂, 104₃, 104₄, and 104₅ are accelerated by gravity vector g. Of course, substrate 101 need not be disposed perfectly horizontally. The apparatus illustrated in FIG. 5A includes electrodes 502 (referred to as the emitter), electrode 504 (referred to as the extractor) and electrode 506 (referred to as the collector). In some embodiments, electrode 504 is perforated so as to allow droplets to pass through. The size and arrangements of the openings in electrode 504 may be arranged to uniformize the magnitude of the electric field near the various emitters. When a voltage is applied between electrodes 502 and 504, an electric field arises. If the magnitude of the electric field near the emitters is sufficiently large to overcome the surface tension of the liquids' menisci, Taylor cones are formed and, as a result, core-shell droplets 510 are generated. In the embodiments in which the emitters have a tapered shapes, the electric field may concentrate in the regions near the emitters, thus decreasing the electric field needed to generate Taylor cones. The electric field between electrodes 504 and 506 may be oriented in any suitable way (to accelerate or decelerate the core-shell droplets). It should be appreciated that, to generate Taylor cones, the liquids need not have large conductivities, as even a few μS/m (or even less in some circumstances) may be sufficient.

An exemplary core-shell droplet is illustrated in FIG. 5B. Core-shell droplet 510 includes core liquid 511 and shell liquid 512, where shell liquid 512 encloses core liquid 510. In some circumstances, for example for forming drug-loaded microcapsules, it may be desirable to solidify the shell liquid and/or the core liquid of a droplet. Referring back to FIG. 5A, in some embodiments this may be accomplished by making the shell out of a photopolymerizable material and by using a light emitter 520 (e.g., an ultraviolet emitter). The light emitter may have a wavelength and an intensity configured to cure the shell and/or core liquid as desired. For example, multiple core-shell droplets may be collected in a tank filled with a liquid immiscible with the shell material, and the tank may be illuminated thereby curing the droplets.

### III. Non-Limiting Examples of Coaxial Electrospray Devices

In one example, the device of FIG. 2A was fabricated using stereolithography with a layer thickness of 25 μm and tolerances of 50 μm in the xy-plane and 125 μm in the z-direction. The used photosensitive resin was an opaque green, ABS-like material with a tensile modulus of 305,000 psi, hardness (Shore D) 85 and elongation to break of 6.1%.

The representative device illustrated in FIG. 6 has a 7.5 mm by 24.24 mm by 24.25 mm substrate with two reservoirs each having a capacity of 0.2 ml. The substrate includes four through-holes used to clamp the device to a chuck configured to hold the substrate. Curved spill guards are formed between the emitter and the through-holes to protect the surface of the substrate from liquid spills.

Two models, with different dimensions, were fabricated for testing different emitter density: one with a 500-μm spout diameter and one with a 450-μm spout diameter. The main dimensions for both models are listed in Table 1.

TABLE 1

| Device | 500-μm | 450-μm |
|---|---|---|
| # of emitter per cm² | 1, 4, 9 | 1, 16, 25 |
| Inlet Diameter [μm] | 800 | 700 |
| Outlet Diameter [μm] | 500 | 450 |
| Emitter Height [mm] | 12 | 9.35 |
| Spout Height [mm] | 2 | 2 |
| Spiral diameter [mm] | 2.6 | 1.6 |
| Spiral length [mm] | 27 | 19 |
| Reservoir volume [ml] | 0.2 | 0.2 |

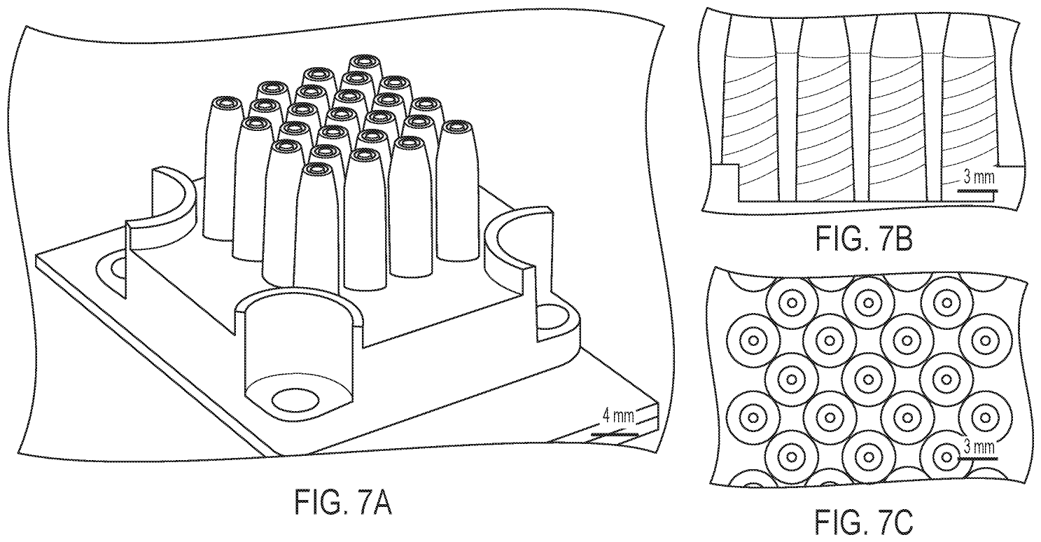

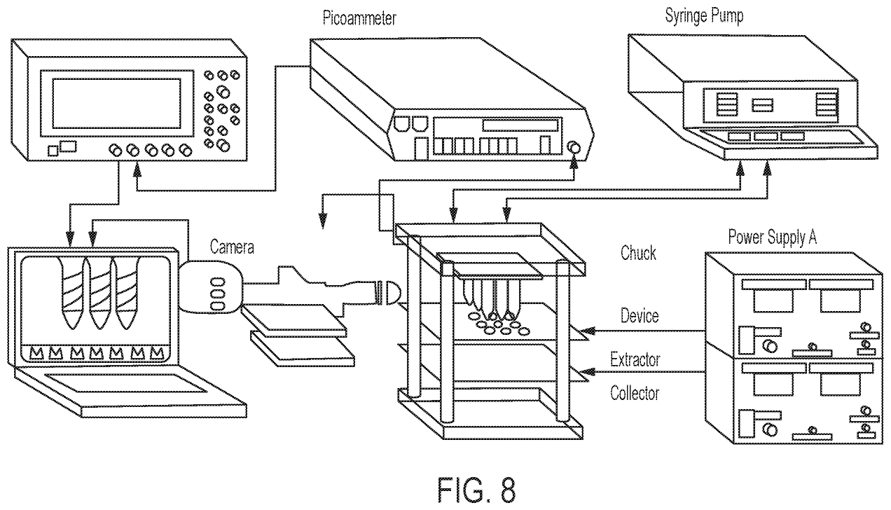

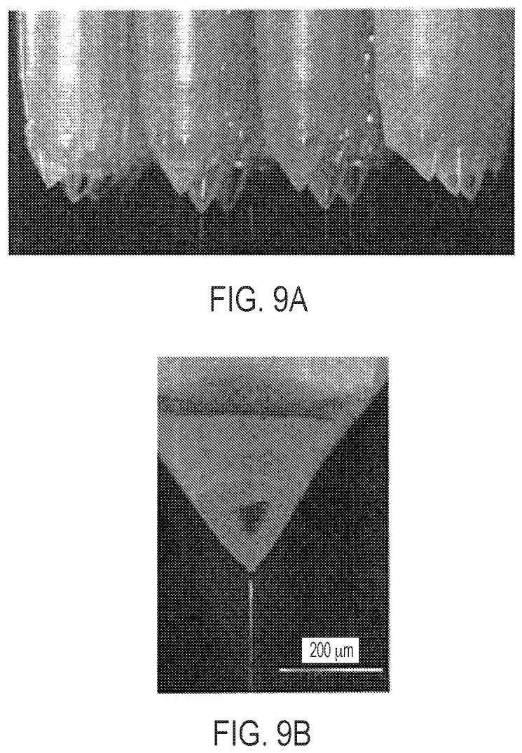

Each device was designed as a CAD and then 3D printed from an exported STL file with deviation tolerance of 2.5 μm and angle tolerance of 6°. Once the device was printed, remaining resin particles were removed by using an ultrasonic bath at 45° C. with a solution of deionized water mixed with isopropanol (1:1 v/v) for 10 minutes. The final appearance of the 3D printed devices with coaxial electrospray emitters is shown in the optical photograph of FIG. 7A. This device includes 25 emitters per cm². FIG. 7B illustrates the helical channels of 3.5 revolutions with a pitch of half of the spiral diameter and a tapered spiral of 2.2°; FIG. 7C illustrates the spouts which enable the formation of the coaxial jet.

Prior to the characterization process, a cleaning process was performed to remove solid residues inside the devices. A loaded 20 ml syringe with isopropyl alcohol was connected to the inlet port of the device; then the liquid was manually fed through the emitters with enough pressure to form continuous jets in all emitters. This process was repeated for both inner and outer liquids channels until homogenous jets among emitter were observed.

a. Characterization

Some of the material parameters contributing to the performance of a coaxial electrospray process include dielectric constant, electrical conductivity K, surface/interfacial tension, and viscosity. In some coaxial electrospray systems, it is desirable that the driving liquid (the one with the smaller electrical relaxation time) is the inner liquid. The electrical relaxation time, to =βε₀/K is the time required to smooth a perturbation in the electrical charge; ε₀ being the vacuum permittivity, β is the dielectric constant of the liquid.

Surface tension may play an important factor in maintaining an appropriate equilibrium between the multiple phases and in obtaining core-shell particles. In various examples, solutions of deionized water (DIW) mixed with isopropyl alcohol (ISP) or ethylene glycol (EG) were selected as the driving liquids and sesame oil (SO) was selected as the driven liquid.

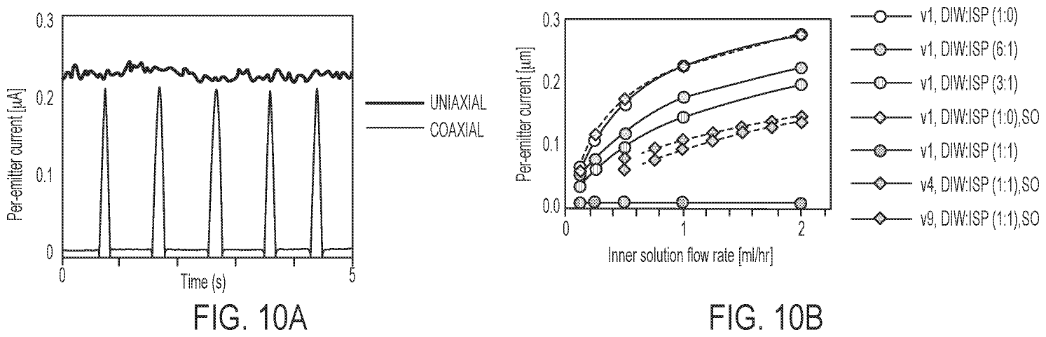

The experimental apparatus shown in FIG. 8 was utilized for the characterization of the 3D printed devices. As part of the characterization process, recording of the per-emitter current versus the per-emitter flow rate was performed. The per-emitter currents provide an indication on the stability of the process, and how the flow rates and bias voltage affect the microencapsulation process. In this case, the inner liquid was used as the driver liquid and the outer liquid as the driven liquid. Both liquids were loaded into a syringe controlled by a syringe pump, although the liquid(s) can be flown using any other means including but not limited to using one or more pressure signals. The device was clamped to an aluminum chuck using screws and the liquid feedthrough of the chuck were connected to the syringes. Polymeric screws were used to install extractor and collector electrodes. Laser-cut 250 μm-thick stainless steel plates with apertures that line up with the axes of the coaxial electrospray emitters of the device were used. The aluminum chuck was grounded while a 4.5 kV to 6.5 kV negative bias voltage was applied to both extractor and collector electrodes The emitted current was measured with a picoammeter and recorded with an oscilloscope; the picoammeter was connected in series with a large resistor. To verify the steadiness of the compound cone-jet, the spouts were permanently monitored in a computer set by a 5MP CCD color digital camera attached to a 12× zoom microscope lens. Finally, to measure the droplet size resulting from the breakup of the compound jet, a fluorescent microscope was used (not shown in FIG. 8).

First, the 500-μm model with 16 emitters was tested by feeding a solution of DIW:ISP (6:1 v/v) as the inner liquid. In uniaxial electrospray (i.e., with a single liquid) uniform operation among emitters was reached for flow rates per emitter higher than 2 ml/hr. In this case, steady cone-jets were observed simultaneously in all the emitters. Similarly, 3:1 and 1:1 solutions were used which resulted in minimum flow rates per emitter of 0.5 ml/hr and 0.1 ml/hr, respectively. This result indicates that the surface tension may play an important role in filling in all emitter and breaking up the meniscuses simultaneously. The same test was repeated with EG, resulting with a minimal per-emitter flow rate of 0.2 ml/hr. The properties of surface tension, the viscosity of the DIW:ISP (1:1 v/v) mixture were 25.8 dyn/cm, and 3.7 cP. In the case of EG were 47.7 dyn/cm and 21.0 cP. A DIW:ISP (1:1 v/v) solution was chosen with sesame oil to characterize the 500-μm models (1, 4 and 9-emitter versions). In addition, the pair ethylene glycol with sesame oil was used to characterize both 500-μm and 450-μm models in all 1, 4, 9, 16 and 25-emitters versions.

b. Operating Modes

Different spraying modes may arise according to the magnitude of the electrostatic field and the liquids' flow rates. In the dripping mode, the bias voltage may be such that the electrostatic force on the meniscus is lower than the hydrodynamic forces, the surface tension forces, and gravity. Therefore, the generation of droplets in this regime is set by the balance between gravity and surface tension (i.e., the droplets fall if gravity overcomes the surface tension) but no core-shell droplets are generated in this mode. In the cone-jet mode, the strength of the electric field may be sufficiently large to lead to the formation of a Taylor cone, which may produce core-shell particles through a jet emerging at the apex of the emitter. The cone-jet mode may be stable. However, further increases in the bias voltage may lead, in some circumstances, to emission instability; the multi-jet mode may appear when more than one jet is emitted from the surface of the meniscus.

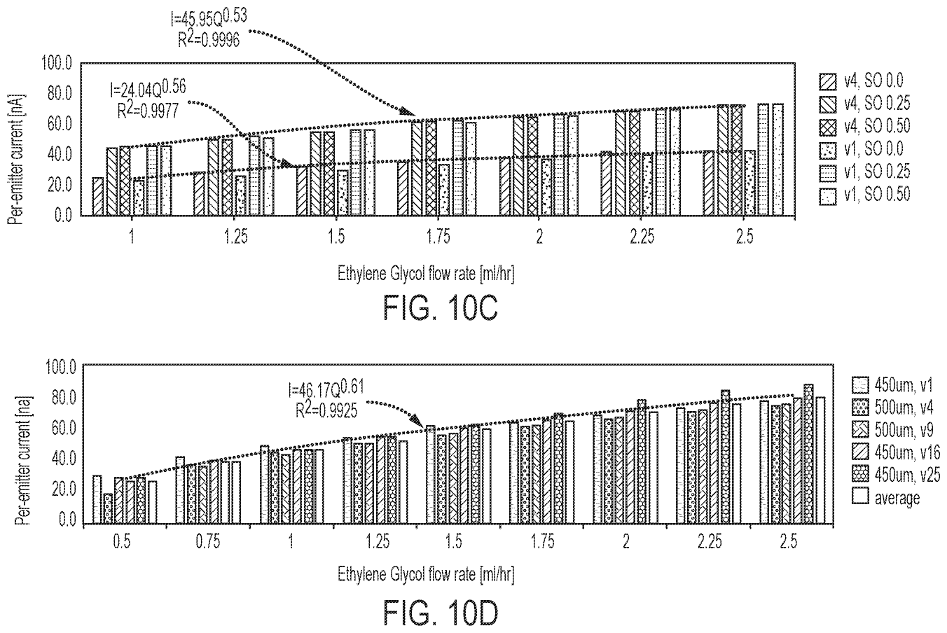

The dripping mode may be identified by random fluctuations in the emitted current, which is in contrast with the steadiness of the emitted current in the cone-jet mode. The emitted current in the cone-jet mode is more constant, even after many minutes of continued emission. FIGS. 9A-9B are photographs illustrating examples of jets in the cone-jet mode.

In an another experiment, when the deionized water and sesame oil flow rates were set at 0.30 ml/hr and 0.10 ml/hr, respectively, and the extractor electrode was positioned 6.4 mm from the emitter spout(s), the cone-jet mode was achieved for extractor bias voltages between −5.4 and −6.3 kV. Similarly, when the extractor electrode was positioned 4.5 mm from the emitter spout(s), a stable Taylor cone was generated at bias voltage between −4.2 kV and −5.9 kV. However, when the extractor electrode was positioned 2.6 mm from the emitter spout(s), the range of bias voltages that generate a stable Taylor cone was −4.5 to −4.8 kV. Accordingly, the extractor voltage and position of the extractor electrode appear to have little effect on the per-emitter current. However, the electrical field acting on the Taylor cone may increase as the separation distance between the emitter spout and the extractor electrode decreases, which may significantly affect the formation of the Taylor cone. Based on this observation, the devices were characterized by placing the extractor electrode 4.75 mm from the emitter spout and with a bias voltage of −5 kV, varying the flow rates of the driven liquid between 0.25 ml/hr to 2.5 ml/hr for two values of sesame oil: 0.25 ml/hr and 0.50 ml/hr.

c. Results

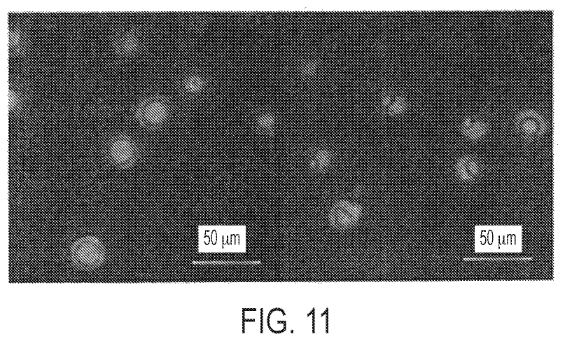

An interesting electrospray behavior was detected when comparing single and coaxial electrospray of deionized water flowing at 1.0 ml/hr by using the 500-μm model, single emitter version. No stable uniaxial electrospray process was achieved. Instead, a spindle mode occurred which became stable once the outer liquid (sesame oil) was fed at 0.125 ml/hr. The per-emitter current in both circumstances was recorded and plotted in FIG. 10A. Even though the spindle mode happens because of unbalanced hydraulic and electrical forces, the higher viscosity of the composed jet with sesame oil allows stabilizing the process.

For an extractor voltage of −5 kV, the effect of the concentration of DIW:ISP on the per-emitter current was investigated by using the single-emitter 500-μm device with solutions 1:1, 3:1 and 6:1. As a result, the per-emitter current reduced as the DIW-ISP proportion increased, since the conductivity of the solution is also decreased. Since in all cases, a stable jet was observed, a 1:1 solution was selected to test the coaxial electrospray of multiplexed devices with four and nine emitters per cm². As can be seen in FIG. 10B, a significant deviation was observed in the per-emitter current curve for both multiplexed devices. For instance, at flow rates of 0.5 ml/hr, 1.0 ml/hr and 2.0 ml/hr, the device with 9 emitters generated 28, 13 and 5% higher per-emitter current respectively, compared to the device having 4 emitters. This may suggest that the proportion of the liquid flow rates has a significant effect.

FIG. 10C illustrates the per-emitter current versus flow rate for the driving liquid (DIW:ISP in this case) using the 500-μm devices (with 1 and 4 emitters). Three different sesame oil flow rates are plotted (0.0 ml/hr, 0.25 ml/hr and 0.50 ml/hr). These experiments show that the scaling law that governs uniaxial electrospray also applies to the coaxial electrospray in this case. However, in this case, the only flow rate that affects the emitted current is that of the driving liquid. Steady per-emitter currents, which are associated with stable cone-jet formation, are proportional to the square root of the per-emitter flow rate of the driving liquid. As illustrated, the per-emitter current is not significantly affected by changes in the driven liquid flow rate. However, there is a significant difference in the scaling law coefficients between single and coaxial electrospray (24.04 and 45.95, respectively). This effect may indicate that sesame oil is inefficient at transporting charge.

FIG. 10D summarizes the characterization of all 3D printed devices for a sesame oil flow rate of 0.50 ml/hr and an extractor electrode voltage of −5 kV. Ethylene glycol was varied between 0.5 ml/hr to 2.5 ml/hr. The per-emitter current curves in the 500-μm and 450-μm devices are substantially the same; this may be due to the fact that the applied voltage can achieve formation of the Taylor cone at either spout size. One important aspect is that uniform operation among the emitters is provided and thus 3D printed devices of the type described herein can be used to increase throughput.

d. Droplets Size Distribution

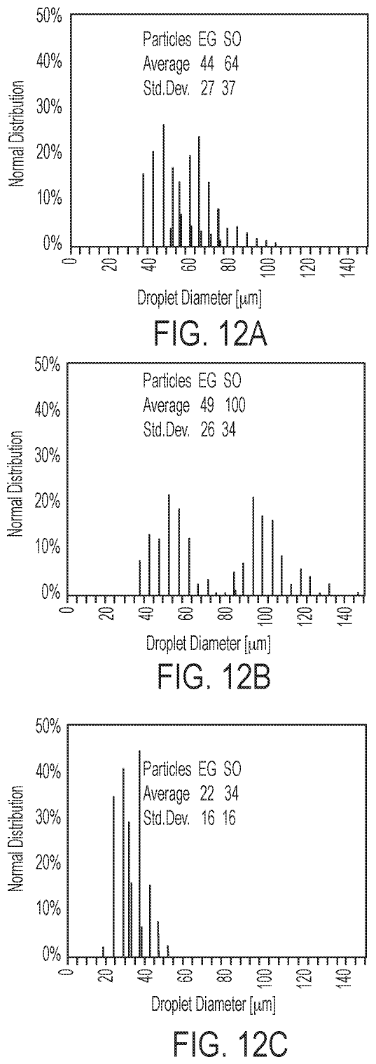

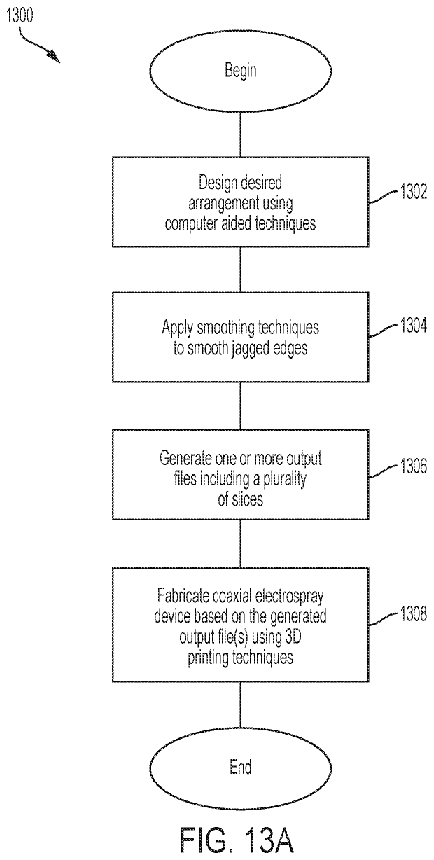

Droplets are generated when a coaxial jet arises. Examples of droplets having Ethylene Glycol encapsulated within sesame oil are illustrated in FIG. 11. FIGS. 12A-12C illustrate various distributions for the diameter of the droplets. In particular, FIG. 12A was obtained with an inner flow rate of 0.50 ml/hr and an outer flow rate of 0.25 ml/hr; FIG. 12B with an inner flow rate of 0.50 ml/hr and an outer flow rate of 0.25 ml/hr but with a larger electric field; and FIG. 12C with an inner flow rate of 0.50 ml/hr and an outer flow rate of 1 ml/hr.

### IV. Fabrication

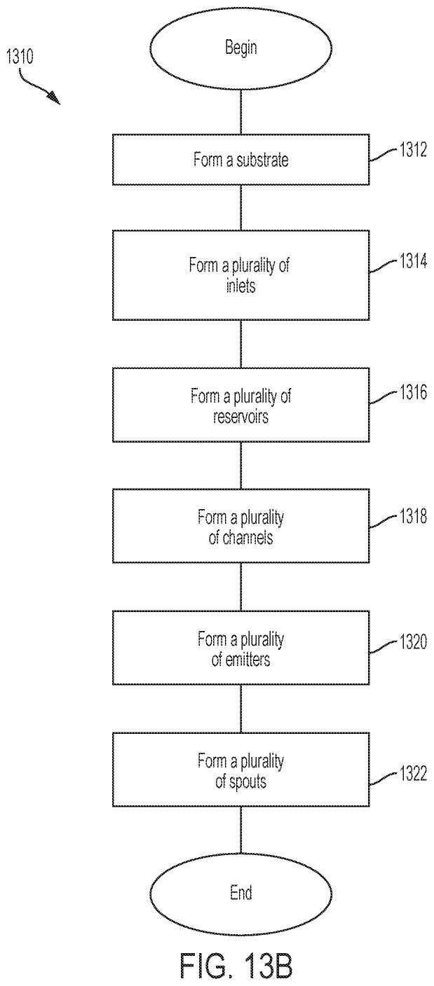

Coaxial electrospray devices of the type described herein may be fabricated using 3D printing techniques, among other fabrication techniques. Representative processes for fabricating a coaxial electrospray device are depicted in FIGS. 13A-13B. Of course other fabrication processes may alternatively or additionally be used. Representative process 1300 begins in act 1302, wherein a desired arrangement is designed using computer-aided techniques, such as computer aided manufacturing (CAM) and/or computer aided design software (CAD). The desired arrangement may specify the size of the substrate, the number and shape of the emitters, reservoirs, channels, intermediate channels, inlets, spouts, etc.

Representative process 1300 may then proceed to act 1304, wherein one or more smoothing techniques may be applied to the desired arrangement, for example to enhance 3D printing resolution. In one example anti-aliasing techniques may be used for producing a shape having smooth edges, where appropriate. Of course, other smoothing techniques may additionally or alternatively be used.

Representative process 1300 then proceeds to act 1306, wherein one or more output files are generated. The output file(s) may be output in a format which defines the designed arrangement in a plurality of slices. The slices may represent the 3D shape in a plurality of planes. One example of such a format is STL, which may be configured to use a series of linked triangles to recreate the surface geometry of the 3D model. In some embodiments, each triangle facet is described by a perpendicular direction and three points representing the corners of the triangle. An STL file may provide a complete listing of the x, y and z coordinates of these corners and perpendiculars.

Representative process 1300 then proceeds to act 1308, wherein a coaxial electrospray device is fabricated based on the output file(s) using 3D printing techniques. One example of a 3D printing technique is stereolithography, which creates models in a layer-by-layer fashion using photopolymerization, a process by which light causes chains of molecules to link, forming for example polymers. Accordingly, layers may be added by focusing an ultraviolet (UV) laser onto a vat of photopolymer resin. The UV laser may be driven to draw the desired arrangement onto the surface of the photopolymer vat. Because photopolymers are photosensitive under ultraviolet light, the resin may solidify and may form a layer of the desired coaxial electrospray device. This process may be repeated for each layer of the coaxial electrospray device. The layer thickness may be between 1 μm and 500 μm, between 1 μm and 40 μm, between 1 μm and 30 μm, between 20 μm and 40 μm, between 20 μm and 30 μm, between 24 μm and 26 μm, or between any suitable range within such ranges. Of course, other values can be used. In some embodiments, a 25 μm-resolution may be used. The fabrication tolerance in the xy-plane may be between 1 μm and 100 μm, between 20 μm and 80 μm, between 30 μm and 70 μm, between 40 μm and 60 μm, between 45 μm and 55 μm, or between any suitable range within such ranges. The fabrication tolerance in the z-axis may be between 1 μm and 200 μm, between 75 μm and 200 μm, between 100 μm and 150 μm, between 115 μm and 135 μm, between 120 μm and 130 μm, or between any suitable range within such ranges. Besides the height of the layers, other parameters may influence the print including but not limited to speed of relative movement between the vat and the platform (the surface on top of which the printed part is attached during printing), delay time between movements, separation between bottom of vat and free end of the printed part, and temperature.

Then, representative process 1300 ends.

An example of act 1308 is depicted in FIG. 13B which illustrates a representative process 1310. It should be appreciated that the acts of representative process 1310 may be formed in a layer-by-layer fashion. For example, in act 1312 a substrate, such as substrate 101, may be formed layer-by-layer. As part of the substrate, a plurality of inlets (act 1314), a plurality of reservoirs (act 1316), a plurality of channels (act 1318), a plurality of emitters (1320), and/or a plurality of spouts (act 1322) may be formed. The numbers and shapes of these components may be formed according the desired arrangement designed in act 1302. In some embodiments, the reservoirs may be formed to include columns. In some embodiments, the channels may be formed to include beams.

### V. Conclusion

The coaxial electrospray devices described herein may be used in a variety of settings, since they may be operated at room temperature. For instance, core-shell and hybrid core-shell droplets of the type described herein may be used, among other applications, in connection with drug delivery, tissue engineering, and plastic surgery.

In one example, microencapsulation may be provided that uses FDA-approved polymers as the shell material, in the context of mass production of drug-loaded microcapsules with precise control of the core-shell geometry. In another example, devices of the type described herein may be used in embedded microactuators, such as electrically sensitive hydrogel beads for regulating the release profile of encapsulated molecules. In yet another example, coaxial electrospray devices of the type described herein may be used for encapsulating ceramic with polymers, for example for use in dental biomaterials, and in bone grafts. In another example, encapsulation of active lipophilic compounds may be used in the food, pharmaceutical and/or flavoring industries for increasing the stability and protection of active compounds. In yet another example, coaxial electrospray devices of the type described herein may be used in the context of self-healing materials (e.g., by encapsulating liquid monomers inside polymer fibers).

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, system upgrade, and/or method described herein. In addition, any combination of two or more such features, systems, and/or methods, if such features, systems, system upgrade, and/or methods are not mutually inconsistent, is included within the inventive scope of the present disclosure.

The terms “about,” “approximately,” and “substantially” may be used to refer to a value, and are intended to encompass the referenced value plus and minus variations that would be insubstantial. The amount of variation could be less than 5% in some embodiments, less than 10% in some embodiments, and yet less than 20% in some embodiments. In embodiments where an apparatus may function properly over a large range of values, e.g., one or more orders of magnitude, the amount of variation could be as much as a factor of two. For example, if an apparatus functions properly for a value ranging from 20 to 350, “approximately 80” may encompass values between 40 and 160.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. A coaxial electrospray device comprising:
a substrate;
an emitter having a proximal end and a distal end, the proximal end being connected to a surface of the substrate, wherein the emitter comprises therein a first channel and a second channel, and wherein the first and second channels extend to the distal end of the emitter; and
first and second reservoirs formed in the substrate, the first reservoir being coupled to the first channel and the second reservoir being coupled to the second channel.

2. The coaxial electrospray device of claim 1, wherein the first channel encloses the second channel within at least a portion of the emitter.

3. The coaxial electrospray device of claim 1, wherein the emitter has a first width at the distal end of the emitter and a second width at the proximal end of the emitter, the second width being larger than the first width.

4. The coaxial electrospray device of claim 1, wherein the first and second channels have helical shapes.

5. The coaxial electrospray device of claim 4, further comprising a spout connected to the distal end of the emitter, wherein the spout comprises an inner tank and an outer tank enclosing the inner tank, wherein the first channel is coupled to the outer tank and the second channel is coupled to the inner tank.

6. The coaxial electrospray device of claim 1, wherein at least one of the first and second reservoirs comprises one or more columns.

7. The coaxial electrospray device of claim 1, wherein the first and second channels have tapered shapes.

8. The coaxial electrospray device of claim 7, wherein each of the first and second channels has a first width at the distal end of the emitter and a second width at the proximal end of the emitter, the second width being larger than the first width.

9. The coaxial electrospray device of claim 8, wherein the first channel has a width that varies continuously between the first width and the second width.

10. The coaxial electrospray device of claim 1, wherein the emitter has a width at the distal end that is between 50 μm and 1 mm.

11. The coaxial electrospray device of claim 1, wherein the emitter has a truncated conical shape.

12. The coaxial electrospray device of claim 1, wherein the substrate is made of a material having a relative dielectric constant that is between 1.0 and 15.

13. The coaxial electrospray device of claim 1, wherein the substrate is made of a material selected from a group consisting of a polymer and a ceramic.

14. The coaxial electrospray device of claim 1, further comprising a plurality of emitters, one of the plurality of emitters being the emitter, each of the plurality of emitters having a proximal end and a distal end, the proximal end being connected to the surface of the substrate, wherein each of the plurality of emitters comprises therein a first channel and a second channel extending to a respective distal end of the emitter, and wherein each of the first channels is coupled to the first reservoir and each of the second channels is coupled to the second reservoir.

15. The coaxial electrospray device of claim 14, wherein the plurality of emitters are arranged with a surface density that is between 1 emitter/cm² and 1000 emitters/cm².

16. The coaxial electrospray device of claim 14, wherein the plurality of emitters are arranged in a honeycomb configuration.

17. The coaxial electrospray device of claim 1, wherein the first channel has a length, measured between the distal end of the emitter and the proximal end of the emitter, that is between 10 and 1000 times larger than a maximum width of the first channel.

18. The coaxial electrospray device of claim 1, wherein at least one between the first and the second channel comprises a plurality of supporting beams.

19. A method comprising:
conveying a first liquid into a first inlet of a substrate and a second liquid into a second inlet of the substrate, the first and second liquids being immiscible;
causing the first liquid to enter a first reservoir formed in the substrate and the second liquid to enter a second reservoir formed in the substrate;
causing the first liquid to form a first plurality of menisci in respective emitters of a plurality of emitters, the plurality of emitters being connected to and protruding from the substrate, and causing the second liquid to form a second plurality of menisci in the respective emitters, wherein at least one meniscus of the second plurality of menisci encloses, in a plane, a respective meniscus of the second plurality of menisci; and
causing the at least one meniscus of the first plurality of menisci and the at least one meniscus of the second plurality of menisci to form a Taylor cone.

20. The method of claim 19, wherein causing the at least one meniscus of the first plurality of menisci and the at least one meniscus of the second plurality of menisci to form a Taylor cone comprises exposing the plurality of emitters to an electric field.

21. The method of claim 19, wherein the electric field has a magnitude, in a region proximate the plurality of emitters, sufficiently large to generate an electric force larger than a maximum surface tension of the first and second plurality of menisci.

22. The method of claim 19, wherein each meniscus of the second plurality of menisci encloses a respective meniscus of the second plurality of menisci.

23. A method for fabricating a coaxial electrospray device, the method comprising:
3D printing a substrate;
3D printing an emitter with a proximal end and a distal end, the proximal end being connected to a surface of the substrate, wherein the emitter comprises therein a first channel and a second channel, and wherein the first and second channels extend to the distal end of the emitter; and
wherein 3D printing the substrate comprises forming first and second reservoirs, the first reservoir being coupled to the first channel and the second reservoir being coupled to the second channel.

24. The method of claim 23, wherein the 3D printing of the substrate and the emitter is based on an output file defining a plurality of slices.

25. The method of claim 24, wherein the output file includes jagged edges.

26. The method of claim 23, further comprising forming a spout such that the spout is connected to the distal end of the emitter, wherein the spout comprises an inner tank and an outer tank enclosing the inner tank, wherein the first channel is coupled to the outer tank and the second channel is coupled to the inner tank.
